(19) United States
(12) Patent Application Publication
(10) Pub. No.: US 2021/0015588 A1
(43) Pub. Date: Jan. 21, 2021

(54) BONE IMPLANT HAVING AN ANCHORING PART MADE OF A BIOCOMPATIBLE PLASTIC

(71) Applicant: Ljubinko PETROVIC, Solothurn (CH)

(72) Inventor: Ljubinko PETROVIC, Solothurn (CH)

(21) Appl. No.: 16/957,729

(22) PCT Filed: Dec. 21, 2018
(86) PCT No.: PCT/DE2018/101038

§ 371 Date: Sep. 30, 2020

(30) Foreign Application Priority Data
Dec. 28, 2017 (DE) 10 2017 012 134.6

(51) Int. Cl. A61C 8/00

(52) U.S. Cl. CPC A61C 8/0075; A61C 8/0068; A61C 8/0016

(57) ABSTRACT

A bone implant includes an anchoring part and a structural part. The anchoring part includes a substantially cylindrical or frustoconical first portion with an external screw thread, which is configured to be implanted in a bone by a turning motion, and a second portion, which is configured to be arranged in a region of soft tissue. The anchoring part is formed from a first, biocompatible plastic and has a recess which extends from a top surface of the second portion into the first portion and which has an internal screw thread in a first thread portion. The structural part has a second thread portion configured to be screwed together with the first thread portion.

### CROSS REFERENCE TO RELATED APPLICATIONS

This application is a U.S. National Phase Application under 35 U.S.C. § 371 of International Application No. PCT/DE2018/101038, filed on Dec. 21, 2018, and claims benefit to German Patent Application No. DE 10 2017 012 134.6, filed on Dec. 28, 2017. The International Application was published in German on Jul. 4, 2019, as WO 2019/129324 A1 under PCT Article 21(2).

### FIELD

The invention relates to a bone implant, and in particular, to a dental implant comprising an anchoring part made of a first biocompatible plastic and a structural part, wherein the anchoring part is essentially cylindrical or frustoconical and has a first portion which is designed to be implanted into bone, and in particular, into a human jaw bone.

### BACKGROUND

For example, EP 2 829 250 B1 discloses in principle the construction of a generic two-part implant. By way of example, EP 1 825 830 B1 discloses a two-part implant made of ceramic for anchoring artificial teeth, wherein the implant is divided into a bone contact surface and a soft tissue contact surface, wherein the bone contact surface and the soft tissue contact surface are roughened and hydroxylated by hydroxy groups present in the outermost atomic layer of the implant surface and are hydrophilic, the entire implant having been treated in the same manner.

DE 103 34 366 A1 discloses a tooth implant having a base body or a component, wherein the base body or the component for the tooth implant comprises a core made of a non-metallic material, in particular plastic, in particular polyether ether ketone or the like, and wherein the core of the component or of the base body has a thin metal-containing layer adhering firmly to the core.

DE 20 2014 004 751 U1 discloses an implant consisting of an elongated anchoring portion extending in the longitudinal direction along a central longitudinal axis and an implant stump, wherein the implant consists at least partially of an implantable material, wherein the anchoring portion has an elongated core from which several anchoring claws extend roughly radially outwards in the longitudinal direction and in the circumferential direction, wherein precisely three anchoring claws in each case are arranged on a common core section at the core circumference. Polyether ether ketone is proposed here in particular as implantable material.

### SUMMARY

In an embodiment, the present invention provides a bone implant. The bone implant includes an anchoring part and a structural part. The anchoring part includes a substantially cylindrical or frustoconical first portion with an external screw thread, which is configured to be implanted in a bone by a turning motion, and a second portion, which is configured to be arranged in a region of soft tissue. The anchoring part is formed from a first, biocompatible plastic and has a recess which extends from a top surface of the second portion into the first portion and which has an internal screw thread in a first thread portion. The structural part has a second thread portion configured to be screwed together with the first thread portion.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a two-part dental implant;

FIG. 2 shows a section through an anchoring part of a dental implant according to a first embodiment of the invention;

FIG. 3 shows a section through an anchoring part of a dental implant according to a second embodiment of the invention; and

FIG. 4 shows a modification of the anchoring part of the dental implant according to the second embodiment.

### DETAILED DESCRIPTION

The present disclosure provides an implant which has excellent biocompatibility combined with ideal physical properties and at the same time is largely compatible with existing implant systems, in particular on the basis of titanium implants.

The disclosure relates to a bone implant, in particular dental implant having an anchoring part and a structural part, wherein the anchoring part has a substantially cylindrical or frustoconical first portion with an external screw thread, which is designed to be implanted in a bone by a turning motion, and a second portion, which is designed to be arranged in the region of the soft tissue, wherein the anchoring part is formed from a first, biocompatible plastic, in particular polyether ether ketone, and has a recess, which is designed to extend from a top surface of the second portion into the first portion and which has an internal screw thread in a first thread portion, the structural part having a second thread portion designed to be screwed together with the first thread portion.

It is particularly advantageous and explicitly desired that the anchoring part described can be implanted with the auxiliary means and tools customary in the art, as are known, in particular, from titanium-based implant systems. In the alternative, the modifications of the auxiliary means or tools should only be necessary to a small extent. It is also explicitly desired that the structural part can be designed identically to that which constitutes standard practice in the field. This approach to the standard that constitutes standard practice in the field serves for simplified handling and integration into existing systems without having to accept their disadvantages.

The term “basically cylindrical” is to be understood to mean that the basic shape is cylindrical, and indeed necessarily only in the first portion which is screwed into the bone. Irrespective of this, the second portion can basically also have a very small longitudinal extent in comparison with the first, as a result of which the anchoring part can be arranged almost completely in the jaw bone. The term “frustoconical” is basically understood to be analogous, wherein mixed forms, that is to say with a transition from a cylindrical shape following the second portion to a frustoconical shape in the further course, are also to be understood hereunder.

The geometric dimensions and embodiments of the external thread can, in principle, be simulated here in a similar manner or even in the same way as in the various prior art.

Here, it is particularly preferred for the material of the anchoring part to consist explicitly exclusively of the first biocompatible plastic in its pure form or in its pure form with admixtures for changing the physical properties, in particular the modulus of elasticity, without further reinforcements or coatings.

It may be particularly advantageous if the first portion of the anchoring part has a first external rough surface, while the second portion of the anchoring part has a second smooth surface in comparison therewith.

In this case, the first rough surface can be structured, preferably irregularly, and preferably have a first roughness Ra, in accordance with DIN 4760, between 1 μm and 30 μm, preferably between 3 μm and 10 μm. The roughness can be determined by means of measurement methods according to EN ISO 25178.

Furthermore, the second smooth surface may have a second roughness Ra of less than 1 μm, preferably less than 0.2 μm.

The structural part is preferably formed from a metallic or a ceramic material or from a plastic, preferably from polyether ether ketone, or from a composite of at least two of these materials.

It is particularly preferred if the first plastic has a modulus of elasticity which is between 3 GPa and 18 GPa, preferably between 10 GPa and 15 GPa, and in particular between 11 GPa and 13 GPa. This plastic can be designed as a thermoplastic, in particular polyether ether ketone, in particular with admixtures which increase the modulus of elasticity. Such an admixture can consist, in particular, of carbon. These are in each case admixtures which result in a plastic body which preferably does not yet have the form of an anchoring part, they are not subsequent modifications of the plastic body. Particularly preferably, the anchoring part can be produced by means of mechanical processing of a plastic basic body or also by means of typical plastic injection methods and, if necessary, mechanical reworking.

In principle, it is advantageous if the first thread portion is designed to be connected to the second thread portion in a force-fit and/or material-fit manner. An adhesive material for material-fit connection can be arranged for the material-fit connection between the first and second thread portions.

In principle, it is also advantageous if the first thread portion is arranged either in the region of the first portion or both in the region of the first and of the second portion.

Depending, in particular, on the modulus of elasticity of the first plastic, it can be advantageous if the first thread portion extends into the first portion to a depth of at least 55%, preferably of at least 65% and particularly preferably of at least 75% of the length of the first portion. Such an embodiment preferably requires a modified tool for implantation, in particular during the rotational movement for implantation, in comparison with the prior art. In particular, an adaptation to the length of the thread portion is necessary here.

In such an embodiment of the first thread portion, it may be advantageous if the first thread portion is designed to be partially filled with a second plastic after the implantation. Depending on the length of the first thread portion, said portion can be filled after implantation to a filling height of at least 20%, preferably of at least 30% and particularly preferably of at least 40%. This filling thus takes place after the implantation of the anchoring part in the bone.

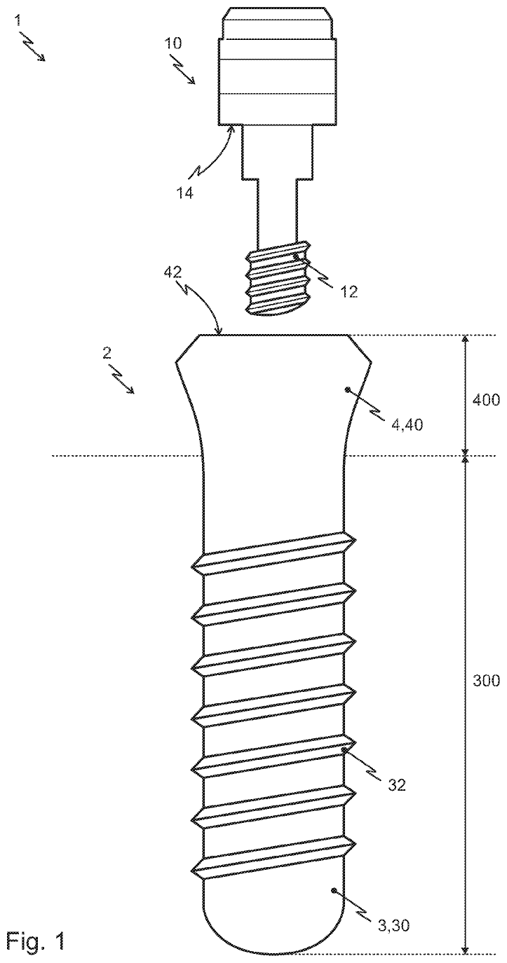

FIG. 1 shows a two-part dental implant 1 according to the present disclosure. This dental implant 1 has an anchoring part 2 and a structural part 10. The anchoring part 2 consists of polyether ether ketone with carbon reinforcements and has a modulus of elasticity of 12 GPa, which is thus very close to the modulus of elasticity of bone substance.

The anchoring part 2 is adapted to be partially implanted in the human jaw bone. For this purpose, the anchoring part 2 has a first portion 3 with a first length 300 which is generally cylindrical in shape and has an external thread 32 at least in one section. This design constitutes standard practice in the field. The entire first surface 30 of the first portion 3 of the anchoring part 2 has a rough surface with a roughness Ra of 5 μm or at least 5 μm.

The anchoring part 2 furthermore has a second portion 4 with a second length 400 which is designed to be arranged in the region of the soft tissue of a human jaw. This second portion 4 has a smooth second surface 40 with a roughness Ra of 0.8 μm. In principle, the length 400 of this second portion 4 can also be only very small compared to the length 300 of the first portion 3. In this embodiment, the ratio of the lengths of the first to second portion is in the range of 4:1. This ratio can in principle be up to 25:1 or in certain applications also beyond that.

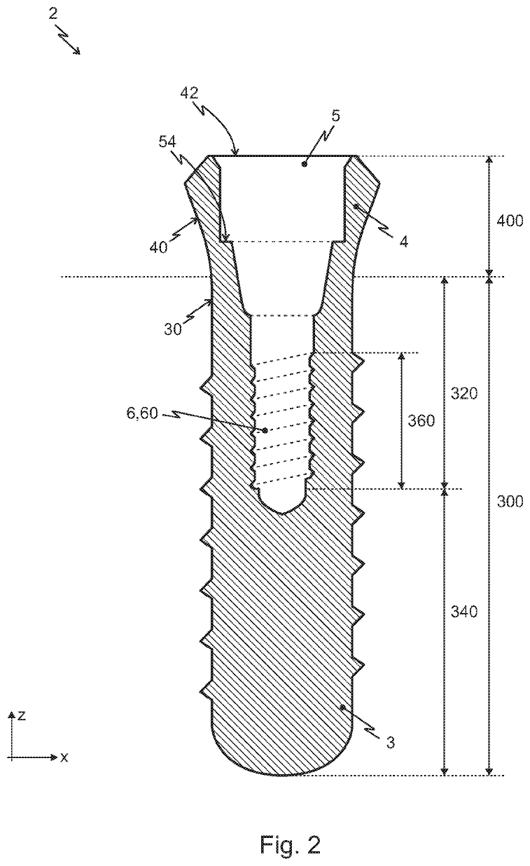

The anchoring part 2 has, cf. FIGS. 2 to 4, a recess 5 which extends from a top surface 42 of the second portion 4 into the first portion 3 and has a first thread portion 6 with an internal thread 60.

This internal thread 60 of the first thread portion 6 is designed to be screwed to a second thread portion 12 of the structural part 10 and thus to connect the structural part 10 to the anchoring part 2 in a force-fit and, if necessary, additionally material-fit manner.

The structural part 10 can in principle be formed as desired from a metallic material or from a ceramic material or from a plastic or from a composite of at least two of these materials. Not shown, it may also already comprise the artificial tooth.

The external, in particular geometric, design of the dental implant 1 of this exemplary embodiment is essentially identical to already known dental implants, irrespective of whether these consist of a ceramic or a metallic material.

FIG. 2 shows a section through an anchoring part 2 of a first embodiment of a dental implant 1. Said anchoring part 2 is, in principle, constructed identically to that described in FIG. 1 with respect to the external embodiment.

Starting from the top surface 42 of the second portion 4, the anchoring part 2 has a recess 5 which extends into the first portion 3. This recess 5 has, in principle, a design constituting standard practice in the field, in this case even compatible with known recesses of titanium-based implant systems, and extends to the center of the first portion 3.

Furthermore, a first thread portion 6 of the recess 5 is shown, wherein this first thread portion 6 has an internal thread 60. Within the scope of the exemplary embodiment, the geometric configuration, that is to say the pure dimensioning, is identical to an embodiment constituting standard practice in the field of anchoring parts made of titanium. The thread portion 6 lies completely in the first portion 3 of the anchoring part 2.

The depth 320 of the recess 5 up to the end of the thread portion 6 in the first portion 3 is here less than 50% of the total length 300 of the first portion 3, wherein the thread portion 6 extends approximately to the end of the recess 5. Thus, the remaining section of the first portion 3 beyond the thread portion 6 has a length 340 that is greater than the length 320 of the section of the first portion 3 to the end of the thread portion 6. Here, the length 360 of the first thread portion 6 is less than the depth 320 of the recess 5 to the end of the thread portion 6, whereby the thread portion 6 is completely disposed in the first portion 3 of the anchoring part 2.

In the scope of the exemplary embodiment, the recess 5 has a first bearing surface 54 which corresponds to a second bearing surface 14 of the structural part 10, cf. FIG. 1. Thus, after the connection of the structural part 10 to the anchoring part 2, the two bearing surfaces 14, 54 rest at least partially on top of one another.

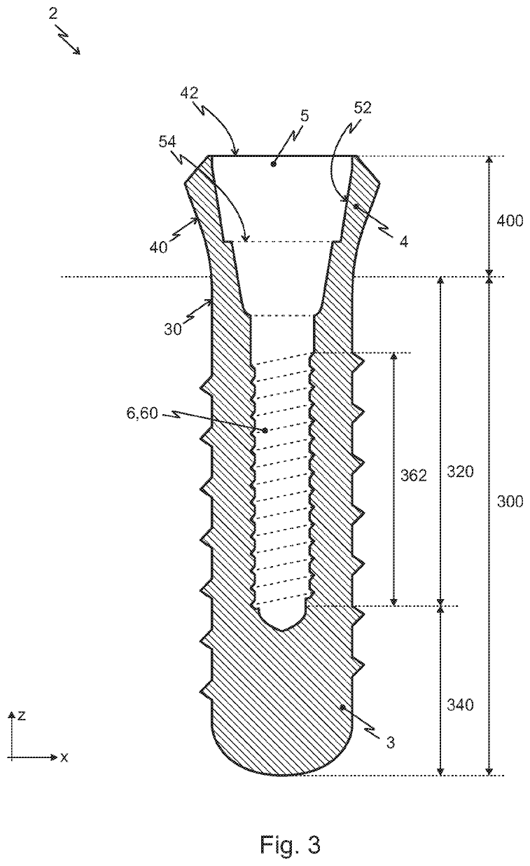

FIG. 3 shows a section through an anchoring part 2 of a second embodiment of a dental implant 1. The anchoring part 2 has the same material with the same surface condition as that of the first embodiment.

In contrast to the first embodiment, in this second embodiment the recess 5 is deeper and has in its profile a side face 52 having a conical profile with a cone angle of approximately 5 degrees within the second portion.

In principle, the larger depth of the recess 5 in the first portion 3 is independent thereof, wherein here as well the thread portion 6 again extends approximately to the end of the recess 5. This embodiment is particularly advantageous since the auxiliary means, not shown, for anchoring the anchoring part 2 can thereby engage further in the first portion 3. This requires auxiliary means modified with respect to the prior art having a longer thread portion. By means of this auxiliary means, the force transmission via the internal thread 60 of the thread portion 6 can take place on a greater length of the anchoring part 2 as compared with the first embodiment of FIG. 2. The anchoring part 2 is in this case conventionally introduced into the bone by means of the auxiliary means in a turning motion, wherein the external thread 32 is screwed into an advantageously preformed internal thread of the bone. This embodiment is particularly advantageous, in particular since the modulus of elasticity of the anchoring part 2 is almost a magnitude less than that of anchoring parts made of titanium.

The depth 320 of the recess 5 up to the end of the thread portion 6 in the first portion 3 is here less than approximately 75% of the total length 300 of the first portion 3. In this case, the internal thread 60 has, in comparison with the first embodiment, a length 362, which is approximately twice the length 360 of the first embodiment. Thus, the remaining section of the first portion 3 beyond the thread portion has a length 340 which is approximately 25% of the length of the section of the first portion 3 to the end of the thread portion 60.

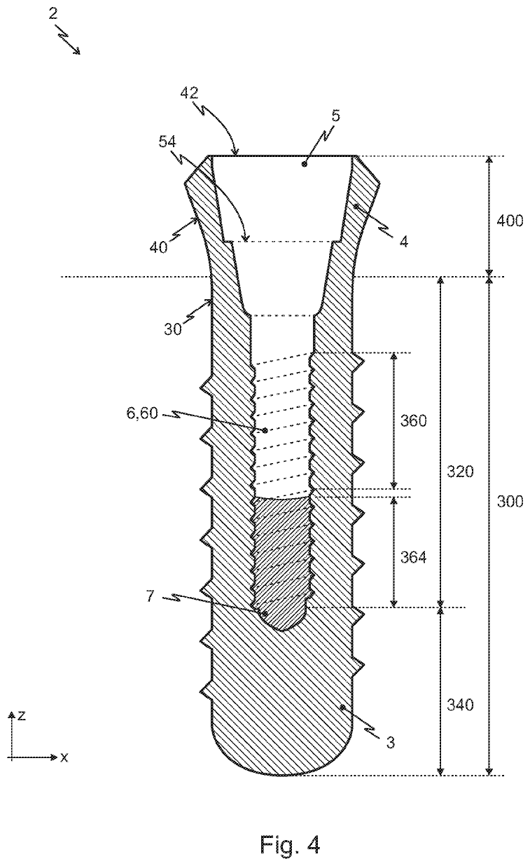

FIG. 4 shows a modification of the anchoring part 2 of the second embodiment. In this case, once the anchoring part 2 was implanted, the recess 5 was partially filled. In this embodiment, the recess 5 is partially filled with a UV-cured second plastic 7 constituting standard practice in the field. The filling height 364 from the end of the thread portion 6 is dimensioned such that the remaining, unfilled thread portion has a length which is exactly or at least equal to the length 360 of the prior art, according to the first embodiment. In this embodiment, the thread portion 6 has been filled with the second plastic 7 to approximately 40%.

Due to the filling, the strength of the anchoring part 2 according to this embodiment with a deeper recess 5 originally, that is to say before the implantation, is aligned with that of the first embodiment.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A bone implant comprising:
an anchoring part; and
a structural part,
wherein the anchoring part includes:
a substantially cylindrical or frustoconical first portion with an external screw thread, which is configured to be implanted in a bone by a turning motion, and
a second portion, which is configured to be arranged in a region of soft tissue,
wherein the anchoring part is formed from a first, biocompatible plastic and has a recess, which extends from a top surface of the second portion into the first portion and which has an internal screw thread in a first thread portion, and
wherein the structural part has a second thread portion configured to be screwed together with the first thread portion.

2. The implant according to claim 1, wherein the first portion has a first external surface which has an irregular structure and which has a first roughness Ra of between 1 μm and 30 μm.

3. The implant according to claim 1, wherein the second portion has a second external surface which is smooth and which has a second roughness Ra of less than 1 μm.

4. The implant according to claim 1, wherein the structural part is formed from a metallic material, a ceramic material, a plastic, or
wherein the structural part is formed from a composite of at least two of the group consisting of a metallic material, a ceramic material, and a plastic.

5. The implant according to claim 1, wherein the first, biocompatible, plastic has a modulus of elasticity between 3 GPa and 18 GPa.

6. The implant according to claim 1, wherein the first thread portion is designed to be connected to the second thread portion in a force-fit and/or material-fit manner.

7. The implant according to claim 1, wherein the first thread portion is either arranged exclusively in a region of the first portion or is arranged both a the region of the first and of the second portion.

8. The implant according to claim 1, wherein the first thread portion extends into the first portion to a depth of at least 55% of the length thereof.

9. The implant according to claim 8, wherein the first thread portion is configured to be partially filled with a second plastic after the implantation.

10. The implant according to claim 9, wherein the first thread portion is configured to be filled up to a filling height of at least 20% after implantation.

11. The implant according to claim 1, wherein the first, biocompatible plastic is a polyether ether ketone.

12. The implant according to claim 2, wherein the first roughness Ra is between 3 μm and 10 μm.

13. The implant according to claim 3, wherein the second roughness Ra is less than 0.2 μm.

14. The implant according to claim 5, wherein the first, biocompatible, plastic has a modulus of elasticity between 10 GPa and 15 GPa.

15. The implant according to claim 14, wherein the first, biocompatible, plastic has a modulus of elasticity between 11 GPa and 13 GPa.

16. The implant according to claim 8, wherein the first thread portion extends into the first portion to a depth of at least 65% of the length thereof.

17. The implant according to claim 16, wherein the first thread portion extends into the first portion to a depth of at least 75% of the length thereof.

18. The implant according to claim 10, wherein the first thread portion is configured to be filled up to a filling height of at least 30% after implantation.

19. The implant according to claim 18, wherein the first thread portion is configured to be filled up to a filling height of at least 40% after implantation.
